(19) United States
(12) Patent Application Publication
(10) Pub. No.: US 2010/0060820 A1
(43) Pub. Date: Mar. 11, 2010

(54) SCREEN STRUCTURE FOR FIELD EMISSION DEVICE BACKLIGHTING UNIT

(75) Inventors: James Kleppinger, Lancaster, PA (US); Richard Hugh Miller, Ephrata, PA (US); David Paul Ciampa, Lancaster, PA (US); Peter Michael Ritt, East Petersburg, PA (US); Ernest Edwin Doerschuk, Lancaster, PA (US)

Correspondence Address: Robert D. Shedd, Patent Operations;THOMSON Licensing LLC, P.O. Box 5312, Princeton, NJ, 08543-5312, US

(73) Assignee: THOMSAON LICENSING, BOULOGNE-BILLANCOURT (FR)

(21) Appl. No.: 12/448,285

(22) PCT Filed: Dec. 18, 2006
(86) PCT No.: PCT/US2006/048216

§ 371 Date: Jun. 16, 2009

(51) Int. Cl. G02F 1/13357; G02F 1/1335; H01J 29/06

(52) U.S. Cl. 349/68; 349/71; 313/461

(57) ABSTRACT

A liquid crystal display includes a liquid crystal display front end component joined to a field emission device backlighting unit. The field emission device backlighting unit has a cathode and an anode. The cathode is provided with a plurality of emitter cells. The anode is provided with a screen structure having a plurality of phosphor elements that are each formed as a substantially continuous stripe. Each of the phosphor elements has a plurality of the emitter cells aligned therewith.

### FIELD OF THE INVENTION

The invention relates to liquid crystal display comprising a liquid crystal display front end component and a field emission device backlighting unit. The field emission device backlighting unit includes an anode with a screen structure having phosphor elements formed as substantially continuous stripes wherein a plurality of rows of emitter cells are aligned with each of the phosphor elements.

### BACKGROUND OF THE INVENTION

Liquid crystal displays (LCDs) are in general light valves. Thus, to create an image they must be illuminated. The elementary picture areas (pixels, sub-pixels) are created by small area, electronically addressable, light shutters. In conventional LCD displays, color is generated by white light illumination and color filtering of the individual sub-pixel light transmissions that correspond to the individual Red, Green, and Blue sub-images. More advanced LCD displays provide programmability of the backlight to allow motion blur elimination through scrolling of individual pulsed lights. For example, scrolling can be achieved by arranging a number of cold cathode fluorescent lamps such as the LCD display in U.S. Pat. No. 7,093,970 (having approximately 10 bulbs per display) in a manner that the long axis of the lamps is along the horizontal axis of the display and the individual lamps are activated in approximate synchronism with the vertically progressive addressing of the LCD displays. Alternatively, hot filament fluorescent bulbs can be employed and can likewise be scrolled, with the individual bulbs progressively turning on and off in a top-to-bottom, cyclic manner, whereby the scrolling can reduce motion artifacts. The backlighting lamps are positioned before a diffuser. The LCD display can include a glass plate supporting a color filter and polarizer.

A further improvement to the standard LCD technology can be obtained by utilizing LEDs (Light Emitting Diodes) for the backlights. By arranging such LEDs in a uniformly distributed manner behind the liquid crystal material and providing three sets of LEDs (Blue, Green, and Red) that comprise the entire backlighting system, additional Programmability and additional performance gains can be obtained. Key features of such LED illuminators include superior black levels, enhanced dynamic range, and also the elimination of the color filter. The color filter can be eliminated by operating the backlight and the LCD in a color field sequential manner. While LED backlights can provide excellent image characteristics, their costs are high. As such, a need exist for less expensive alternative LCDs having the performance capabilities of LCDs with LED backlighting.

### SUMMARY OF THE INVENTION

A liquid crystal display includes a liquid crystal display front end component joined to a field emission device backlighting unit. The field emission device backlighting unit has a cathode and an anode. The anode is provided with a screen structure having a plurality of phosphor elements that are each formed as a substantially continuous stripe. Each of the phosphor elements is aligned with a plurality of rows of field emitter cells which are formed on the cathode.

### BRIEF DESCRIPTION OF THE DRAWINGS

The invention will now be described by way of example with reference to the accompanying drawings.

FIG. 1 is a partial sectional view of a liquid crystal display including a liquid crystal display front end component and a field emission device backlighting unit.

FIG. 2 is a plan view of screen structure in the field emission device backlighting unit of FIG. 1.

FIG. 3 is a sectional view of a liquid crystal display including a liquid crystal display front end component and a field emission device backlighting unit, according to the invention.

FIG. 4 is a plan view of a screen structure in the field emission device backlighting unit of FIG. 3.

FIG. 5 is a sectional view of the field emission device backlighting unit of FIG. 3.

FIG. 6 is another sectional view of the field emission device backlighting unit of FIG. 3.

### DETAILED DESCRIPTION OF THE INVENTION

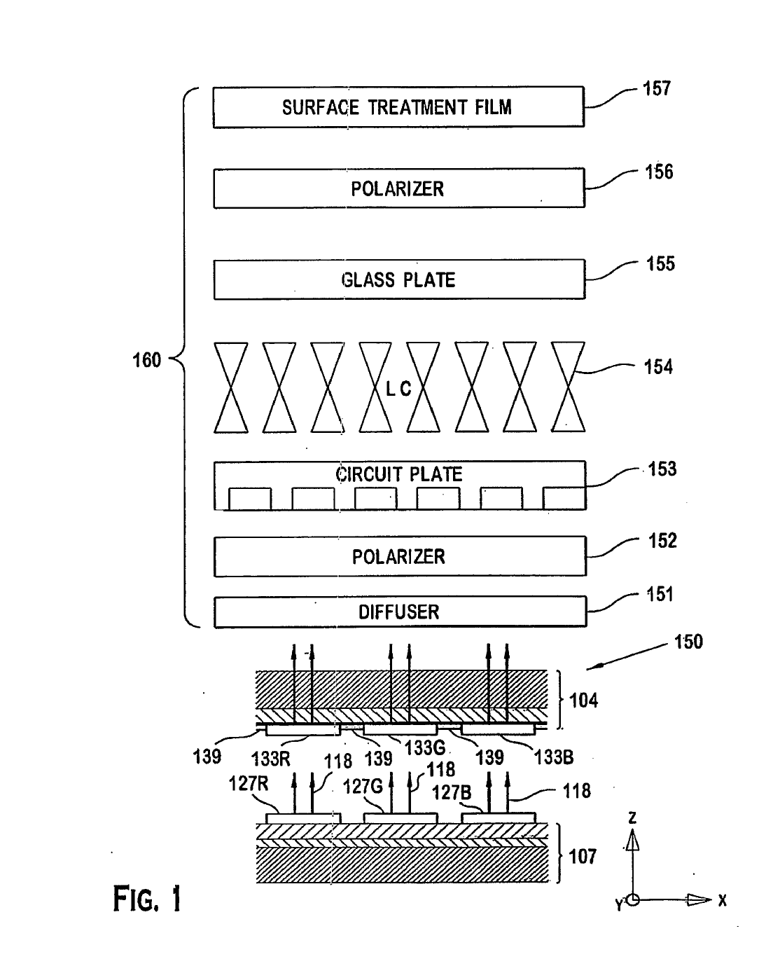

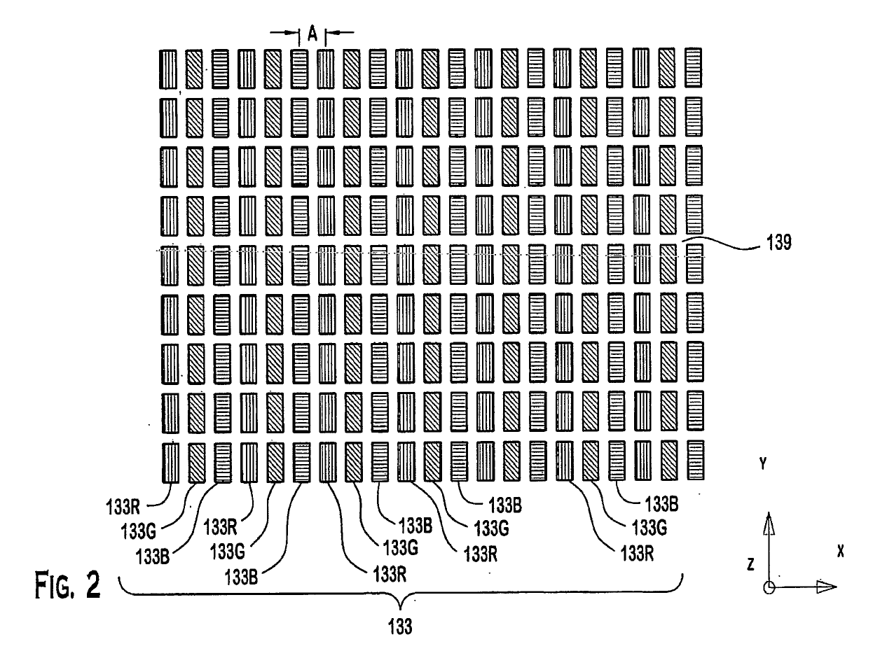

FIGS. 1-2 show an embodiment of a liquid crystal display. As shown in FIG. 1, the liquid crystal display includes a liquid crystal display front end component 160 and a field emission device backlighting unit 150. As shown in FIG. 1, the liquid crystal display front end component 160 consists of a diffuser 151, a polarizer 152, a circuit plate 153, a liquid crystal (LC) 154, a glass plate 155, a second polarizer 156 and a surface treatment film 157. Because the configuration and operation of the diffuser, the polarizer, the circuit plate, the LC, the glass plate, the second polarizer and the surface treatment film are known in the art, further description thereof will not be provided herein.

The field emission device backlighting unit 150 consists of a cathode 107 and an anode 104. The anode 104 is provided with a screen structure consisting of an arrangement of phosphor elements 133. As shown in FIG. 2, the phosphor elements 133 consist of red phosphor elements 133R, green phosphor elements 133G, and blue phosphor elements 133B. The red phosphor elements 133R, the green phosphor elements 133G, and the blue phosphor elements 133B can be formed in columns and rows. (In general, the expression “row” typically refers to horizontal orientation and “column” refers to a vertical orientation; however, in this specification and claims, unless otherwise indicated, “rows” or “columns” can be either horizontal, vertical or some orientation therebetween.) Each column can have only one phosphor element color and the phosphor element colors can cycle along each of the rows. The phosphor elements 133 are arranged at a pitch A of about 1-5 millimeters and can be separated by a black matrix 139. (The black matrix can separate columns or rows or both.) As shown in FIG. 1, the cathode 107 is provided with a plurality of emitter cells which can emit electrons 18. The emitter cells consist of red emitter cells 127R, green emitter cells 127G, and blue emitter cells 127B. The emitter cells are arranged at the same pitch as the phosphor elements 133. When the cathode 107 is sealed to the anode 104, each of the emitter cells must be precisely aligned with each of the corresponding phosphor elements 133. For example, as shown in FIG. 1, each of the red emitter cells 127R must be aligned with the red phosphor elements 133R, each of the green emitter cells 127G must be aligned with the green phosphor elements 133G, and each of the blue emitter cells 127B must be aligned with the blue phosphor elements 133R to ensure that electrons 18 emitted from the emitter cells strike the correct phosphor elements 133.

The configuration of the field emission device backlighting unit 150 shown in FIGS. 1-2 can be improved. Because of the configuration and orientation of the phosphor elements 133, when the screen structure is formed, the phosphor elements 133 must be properly aligned in two directions making the screen structure difficult to manufacture. Additionally, when the cathode 107 is sealed to the anode 104, each of the emitter cells must be precisely aligned with each of the corresponding phosphor elements 133 in two directions so that the electrons 118 emitted from the emitter cells do not strike the incorrect phosphor element 133, which makes alignment critical. Further, because the colored phosphor elements 133 cycle along each of the rows of the screen structure, it is difficult to program the field emission device backlighting unit 150 to energize either a portion or all of each of the rows.

The liquid crystal display in FIG. 3 is a preferred embodiment of the invention. It is easier to program, align, and manufacture, compared to the LCD shown and described in FIG. 1. The liquid crystal display includes a liquid crystal display front end-component 60 and a field emission device backlighting unit 50. In the illustrated embodiment, the field emission device backlighting unit 50 is joined to the liquid crystal display front end component 60 to provide backlighting for the liquid crystal display. The field emission device backlighting unit 50, however, can also be used as direct display device, which does not include the liquid crystal display front end component 60.

As shown in FIG. 3, the liquid crystal display front end component 60 consists of a diffuser 51, a polarizer 52, a circuit plate 53, a liquid crystal (LC) 54, a glass plate 55, a second polarizer 56 and a surface treatment film 57. The diffuser 51 and the polarizer 52 may include brightness enhancement elements such as a VIKUITI™ optical film made by 3M, which increases the brightness of the liquid crystal display by recycling otherwise unused light and optimizing the angle of light incident on the LC 54.

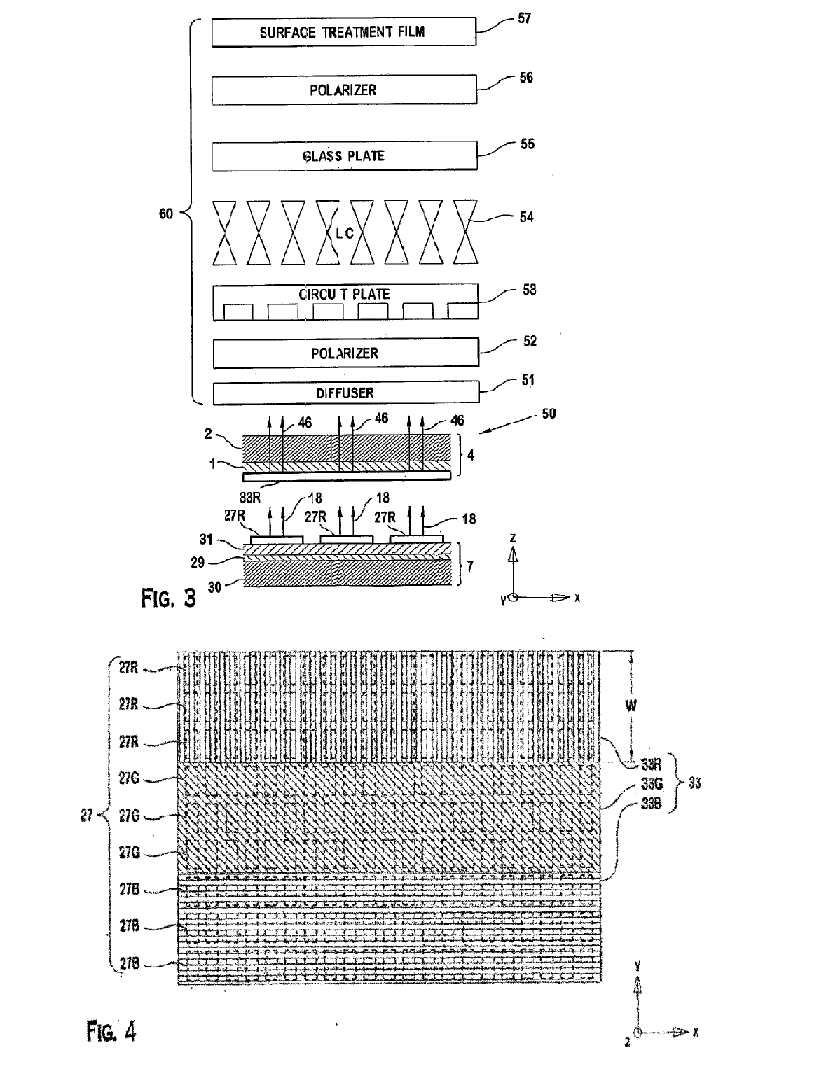

As shown in FIG. 3, the field emission device backlighting unit 50 consists of a cathode 7 and an anode 4. The anode 4 includes a glass substrate 2 having a transparent conductor 1 deposited thereon. The transparent conductor 1 may be, for example, indium tin oxide. Phosphor elements 33 are applied to the transparent conductor 1 to form a screen structure. As shown in FIG. 4, the phosphor elements 33 consist of a red phosphor element 33R, a green phosphor element 33G, and a blue phosphor element 33B. The red phosphor element 33R, the green phosphor element 33G, and the blue phosphor element 33B are formed as substantially continuous stripes that extend substantially parallel to each other. Each of the phosphor elements 33 may have a width W, for example, greater than 1 millimeter. The FED backlight component can have lower resolution than the front-end LCD (i.e. the particular activation of a cell of the backlight can provide the selected color light for a plurality of LCD pixels).

In the illustrated embodiment, each of the phosphor elements 33 abuts an adjacent one of the phosphor elements 33 and each of the phosphor elements 33 extends continuously in a horizontal direction. It will be appreciated by those skilled in the art, however, that the orientation and continuity of the phosphor elements 33 may vary depending on the desired scanning pattern, for example, the phosphor elements 33 could alternatively extend in a vertical direction or at an angle between 0-90 degrees. Additionally, breaks (not shown) could be formed in the phosphor elements 33 to accommodate spacers (not shown) or other devices (not shown) or to accommodate for complex scanning patterns.

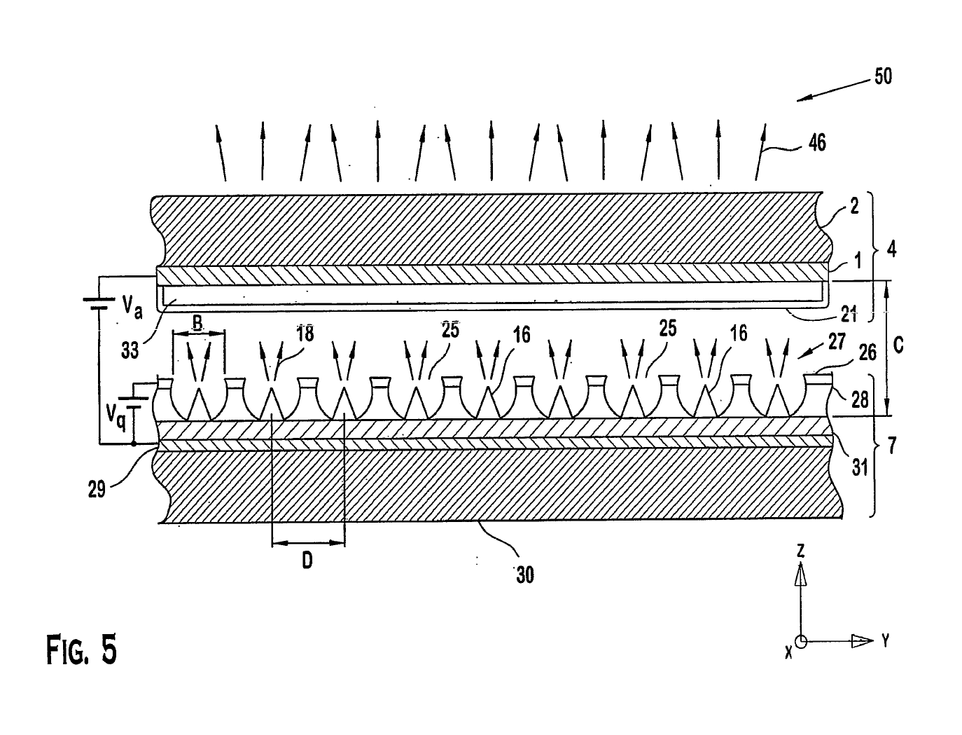

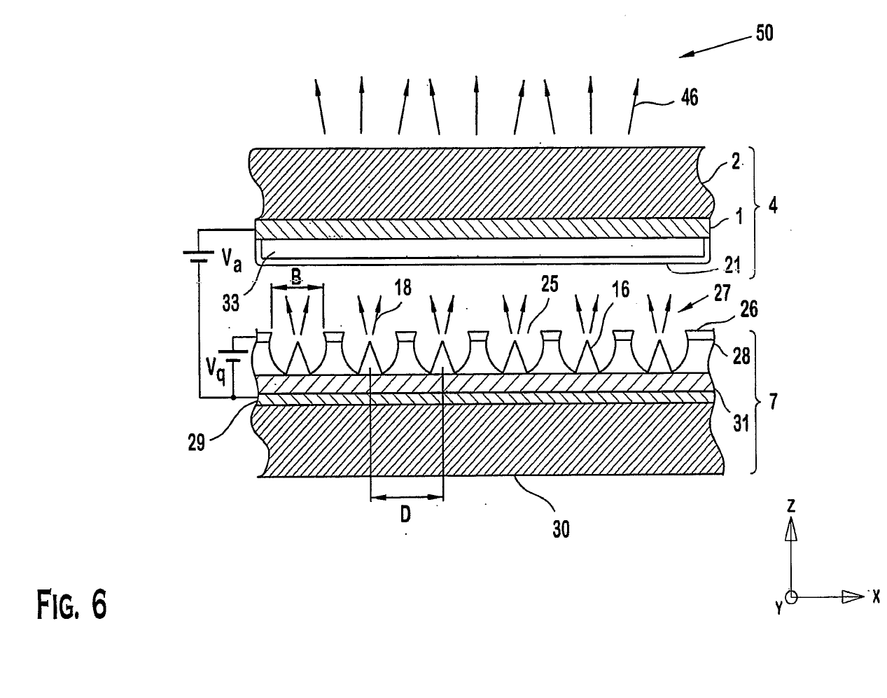

The phosphor elements 33 may be formed from low voltage phosphor materials, cathode ray tube phosphor materials, or non-water compatible phosphor. In the 10-15 kilovolt operating range, cathode my tube phosphor materials are the most suitable. As shown in FIG. 5, a substantially thin reflective metal film 21 may be applied over the phosphor elements 33. The reflective metal film 21 serves to enhance the brightness of the field emission device backlighting unit 50 by reflecting light emitted toward the cathode 7 away from the cathode 7.

As shown in FIGS. 5-6, the cathode 7 includes a dielectric material 28, a dielectric support 31, a back plate 29 and a back plate support structure 30. The dielectric material 28 has a plurality of emitter cells 27. As shown in FIG. 4, the emitter cells 27 consist of red emitter cells 27R, green emitter cells 27G, and blue emitter cells 27B arranged in rows. The cathode 7 may comprise between about 10-2,000 individually programmable rows and columns depending on the desired use of the field emission device backlighting unit 50. As shown in FIGS. 5-6, each of the emitter cells 27 contains a plurality of electron emitters 16. The electron emitters 16 are arranged in an array and have emitter apertures 25. In the illustrated embodiment, the electron emitters 16 are conical microtip emitters, however it will be appreciated by those skilled in the art that other types of electron emitters may be used, such as carbon nanotubes emitters, which can be effective in field emission device backlighting unit 50 operating at an anode potential of about 10 kilovolt or greater in the pixel resolution range of 1 millimeter and larger. The electron emitters 16 have a pitch D of about 15-30 microns. The emitter apertures 25 have an opening dimension B of about 10 microns. Each of the electron emitters 16 is associated with a gate 26. The gate 26 may be supported on the dielectric material 28.

As shown in FIG. 5, the cathode 7 is spaced from the anode 4 a distance C of about 1-5 millimeters. The cathode 7 is sealed to the anode 4 such that a plurality of rows of the emitter cells 27 are aligned with each of the phosphor elements 33, as shown in FIG. 4. In the illustrated embodiment, three rows of the red emitter cells 27R are aligned with the red phosphor element 33R, three rows of the green emitter cells 27G are aligned with the green phosphor element 33G, and three rows of the blue emitter cells 27B are aligned with the blue phosphor element 33R. Because the red, green, and blue phosphor elements 33R, 33G, 33B are formed as substantially continuous stripes and each of the red, green, and blue emitter cells 27R, 27G, 27B are grouped together, precise alignment of the red, green, and blue emitter cells 27R, 27G, 27B with the corresponding red, green, and blue phosphor elements 33R, 33G, 33B is required in only one direction. Although the plurality of rows shown in FIG. 3 for each phosphor elements is 3, the plurality can be another number greater than one.

The operation of the field emission device backlighting unit 50 will now be described. A power source (not shown) applies a potential Va to the anode 4. The power source (not shown) may be, for example, a DC power supply that operates in the 10-20 kilovolt range. A gate potential Vq is applied to the desired gates 26. Due to an electric field created in the cathode 7, the electron emitters 16 emit electrons 18. The electrons 18 travel through the emitter apertures 25 toward the anode 4. The electrons 18 strike the corresponding phosphor elements 33 on the anode 4 thereby causing photon emission with photons 46 to be directed toward the viewer or toward the diffuser 51 of the liquid crystal display front end component 60. The photons 46 emitted are diffused such that white, green, red, and/or blue light pass through pixels of the liquid crystal display when the appropriate red, green, and/or blue phosphor elements 33R, 33G, 33B are activated.

The field emission device backlighting unit 50 may be programmable such that the field emission device backlighting unit 50 can selectively provide specific colored light to specific pixels of the liquid crystal display. When the field emission device backlighting unit 50 is programmable, the liquid crystal display can achieve optimal black levels, wide dynamic range, blur-free motion rendition, and a large color gamut. (Programmability implies intelligent backlighting capability wherein only the needed color light is generated in a particular location of the screen where LCD cells are activated to transmit light.) For example, because each of the rows comprises a single color of the phosphor elements 33, the field emission device backlighting unit 50 can have horizontal programmability wherein either a portion or all of each of the rows of a particular color can be energized. Because all of the phosphor elements 33 of the same color are grouped together, this type of horizontal programmability is easy to process. Additionally, because all of the phosphor elements 33 of the same color are grouped together, spreading of the electrons 18 due to space charge and emission angle associated with these spacings is not detrimental to the color performance of the field emission device backlighting unit 50.

The foregoing illustrates some of the possibilities for practicing the invention. Many other embodiments are possible within the scope and spirit of the invention. For example, in the illustrated embodiment, the field emission device backlighting unit 50 is operated in a color sequential mode, thus no color filters are required in the liquid crystal display front end component 60; however, another embodiment of the invention can include color filters which could provide an opportunity for narrower color wavelength ranges. It is, therefore, intended that the foregoing description be regarded as illustrative rather than limiting, and that the scope of the invention is given by the appended claims together with their full range of equivalents.

1. A liquid crystal display, comprising:
a liquid crystal display front end component; and
a field emission device backlighting unit joined to the liquid crystal display front end component, the field emission device backlighting unit having a cathode and an anode, the cathode being provided with a plurality of emitter cells, the anode being provided with a screen structure having a plurality of phosphor elements that are each formed as a substantially continuous stripe, each of the phosphor elements having a plurality of rows of the emitter cells aligned therewith.

2. The liquid crystal display of claim 1, wherein each of the emitter cells contains a plurality of electron emitters.

3. The liquid crystal display of claim 1, wherein the phosphor elements extend substantially parallel to each ether.

4. The liquid crystal display of claim 1, wherein each of the phosphor elements has a width greater than 1 millimeter.

5. The liquid crystal display of claim 1, wherein the field emission device backlighting unit is programmable.

6. The liquid crystal display of claim 1, wherein each of the phosphor elements abuts an adjacent one of the phosphor elements.

7. The liquid crystal display of claim 1, wherein the phosphor elements consist of a red phosphor element, a green phosphor element, and a blue phosphor element.

8. The liquid crystal display of claim 7, wherein the emitter cells aligned with the red phosphor element consist of red emitter cells, the emitter cells aligned with the green phosphor element consist of green emitter cells, and the emitter cells aligned with the blue phosphor element consist of blue emitter cells.

9. A field emission device, comprising:
a cathode provided with a plurality of emitter cells; and
an anode provided with a screen structure having a plurality of phosphor elements that are each formed as a substantially continuous stripe, each of the phosphor elements having a plurality of the emitter cells aligned therewith.

10. The field emission device of claim 9, wherein each of the emitter cells contains a plurality of electron emitters.

11. The field emission device of claim 9, wherein the emitter cells are arranged in rows and a plurality of rows are aligned with each of the phosphor elements.

12. The field emission device of claim 9, wherein the phosphor elements extend substantially parallel to each other.

13. The field emission device of claim 9, wherein each of the phosphor elements has a width greater than 1 millimeter.

14. The field emission device of claim 9, wherein the field emission device is programmable.

15. The field emission device of claim 9, wherein each of the phosphor elements abuts an adjacent one of the phosphor elements.

16. The field emission device of claim 9, wherein the phosphor elements consist of a red phosphor element, a green phosphor element, and a blue phosphor element.

17. The field emission device of claim 16, wherein the emitter cells aligned with the red phosphor element consist of red emitter cells, the emitter cells aligned with the green phosphor element consist of green emitter cells, and the emitter cells aligned with the blue phosphor element consist of blue emitter cells.
